(19) United States
(12) Patent Application Publication
(10) Pub. No.: US 2026/0340732 A1
(43) Pub. Date: Oct. 29, 2026

(54) SYSTEMS AND METHODS FOR PORTFOLIO MODELING

(71) Applicant: The PNC Financial Services Group, Inc., Pittsburgh, PA (US)

(72) Inventors: Santosh KUMAR, Pittsburgh, PA (US); Jennifer MOREALE, Pittsburgh, PA (US)

(73) Assignee: The PNC Financial Services Group, Inc., Pittsburgh, PA (US)

(21) Appl. No.: 19/353,990

(22) Filed: Oct. 9, 2025

Related U.S. Application Data
(60) Provisional application No. 63/796,062, filed on Apr. 28, 2025.

(51) Int. Cl. G06Q 40/06; G06Q 40/03

(52) U.S. Cl. CPC G06Q 40/0631; G06Q 40/03055; G06Q 40/062

(57) ABSTRACT

Computer implemented methods and systems for feature analysis of at least two datasets are provided. Some embodiments involve accessing, from at least one database, a first dataset and a second dataset, each having a plurality of features. Some embodiments involve a third dataset generated comprising shared features. Some embodiments involve data from all three datasets being provided to a trained general linearized model. Some embodiments involve the model being analyzed to generate a predictive variable indicating feature sensitivity and contribution. The predictive variable may be used to update either the first or second dataset based on a determined maximum allowable value. In some embodiments, improving model performance and predictive analysis across multiple datasets includes comparing the predictive variable to the actual outcome data to evaluate model performance.

### CROSS REFERENCE TO RELATED APPLICATIONS

This application claims the benefit of priority of U.S. Provisional Patent Application No. 63/796,062 filed on Apr. 28, 2025, the contents of which are incorporated herein by reference in their entirety.

### BACKGROUND

When structuring portfolios to optimize returns, analysts and decision makers often evaluate each portfolio in isolation. For example, estimating the probability of default for construction loans separately from income-producing real estate loans such as hotels and rental properties. However, this siloed approach creates several problems. First, it may foster inconsistent treatment of shared features (e.g., loan-to-value ratios and debt-service coverage) when the two separate models factor them differently. Second, it may introduce error when a loan transitions from construction to income-producing property. For example, a hotel construction projects starts as a construction loan and transitions to an income-producing loan after the hotel opens for operation. This may cause the estimated probability of default to jump or drop due to methodological differences rather than real changes in risk. Third, it may waste resources by duplicating analyses on substantively similar data. These issues may be mitigated by identifying shared characteristics across datasets and integrating them into a unified modeling framework that standardizes how similar features are handled, and reliably models transitions (e.g., construction to income-producing real estate). As a result, it may improve stability in predicted outcomes (e.g., probability of default), create continuity across datasets (e.g., loan lifecycles), and reduce unnecessary computational overhead.

The present disclosure relates to feature analysis of at least two datasets. For example, creating risk rating models for financing decisions, portfolios, or loan obligations. The systems and methods described herein could be applied to a commercial real estate portfolio that contains sub-groups such as income-producing real estate, construction, and pool portfolios. According to the disclosed methods and systems, a single model may be developed to capture the risk across all three portfolios that contain both common and distinct features. The model may use a modular structure with common features accounted for in a single module, while portfolio-specific distinct features are assigned to corresponding separate modules. The final integrated model combines all the modules, allowing the model to better capture risk factors across modules enabling it to capture risk throughout the life of the loan. For example, when an obligor transitions from a construction to income-producing stage in their loan, the combined model may better estimate the predicted risk throughout the life of the loan because coefficients are used consistently.

### SUMMARY

The disclosed embodiments describe computer readable mediums, systems, and methods for feature analysis of at least two datasets. For example, the systems and methods may include accessing, from at least one database, a first dataset having a plurality of features and a second dataset having a plurality of features. In some embodiments, at least one of the first plurality of features and at least one of the second plurality of features may be a same feature and at least one of the first plurality of features and at least one of the second plurality of features may be a distinct feature. The systems and methods may further include determining a maximum allowable value of a metric associated with the first dataset and the second dataset and generating a third dataset having a third plurality of features. In some embodiments, the third plurality of features include the same feature of the first dataset and the second dataset. The systems and methods may further include providing data regarding the first plurality of features, the second plurality of features, and the third plurality of features to a trained general linearized model. The systems and methods may further include applying a set of coefficients and a set of model factors to the general linearized model based on model training. In some embodiments, the set of coefficients may be determined during model training to minimize an error between actual outcome factors and predicted outcome factors. The systems and methods may further include analyzing the general linearized model based on the first plurality of features, the second plurality of features, third plurality of features, set of coefficients, and the set of model factors. Embodiments may further include generating a predictive variable associated with the first dataset, the second dataset, and the third dataset. In some embodiments, the predictive variable indicates which model factors contributed to the predictive variable, and the predictive variable indicates a level of sensitivity within the model associated with the model factors. Embodiments may further include updating either the first or second dataset based on the predictive variable and the determined maximum allowable value.

The disclosed embodiments describe computer readable mediums, systems, and methods for improving model performance and predictive analysis across multiple datasets. For example, the systems and methods may include accessing, from at least one database, a first dataset having a plurality of features and a second dataset having a plurality of features and determining a maximum allowable value of a metric associated with the first dataset and the second dataset. According to some embodiments, at least one of the first plurality of features and at least one of the second plurality of features is a same feature, and at least one of the first plurality of features and at least one of the second plurality of features is a distinct feature. The systems and methods may further include generating a third dataset having a third plurality of features, and providing data regarding the first plurality of features, the second plurality of features, and the third plurality of features to a trained general linearized model. According to some embodiments, at least one of the third plurality of features includes the same feature of the first dataset and the second dataset. The systems and methods may further include applying a set of coefficients and a set of model factors to the general linearized model based on model training, and analyzing the general linearized model based on the first plurality of features, the second plurality of features, third plurality of features, set of coefficients, and the set of model factors. According to some embodiments, the set of coefficients is determined during model training to minimize an error between actual outcome factors and predicted outcome factors, and the predictive variable indicates which model factors contributed to the predictive variable, and the predictive variable indicates a level of sensitivity within the model associated with the model factors. The systems and methods may further include generating a predictive variable associated with the first dataset, the second dataset, and the third dataset, and collecting actual outcome data associated with the first dataset, the second dataset, and the third dataset. The systems and methods may further include comparing the predictive variable to the actual outcome data to evaluate model performance, and generating a report on the efficacy of the trained general linearized model.

Throughout this disclosure, the phrase “disclosed embodiments,” refers to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic.

It is to be understood that both the foregoing general description and the following detailed description are exemplary and explanatory only, and are not restrictive of the disclosed embodiments, as claimed.

### BRIEF DESCRIPTION OF THE DRAWINGS

FIG. 1 illustrates a portfolio manager considering integrating loan data in a modular way to capture shifts in risk when loans transition from the construction stage to income-producing, consistent with the disclosed embodiments.

FIG. 2 illustrates capturing loan data into separate modules then integrating the modules, consistent with the disclosed embodiments.

FIG. 3 illustrates example datasets and modules used by the disclosed systems to model financing risk across the lifecycle of a real estate loan, consistent with the disclosed embodiments.

FIG. 4 is a diagram of an exemplary system for financial institutions and risk managers interacting with loan data and integrated statistical models, consistent with disclosed embodiments.

FIG. 5 is a block diagram showing an example computing device, consistent with disclosed embodiments.

FIG. 6 is a flowchart illustrating an example process for feature analysis of at least two datasets, consistent with disclosed embodiments.

FIG. 7 is a diagram of an exemplary system architecture for feature analysis of at least two datasets, consistent with disclosed embodiments.

FIG. 8 is a flowchart illustrating an example process for improving model performance and predictive analysis across multiple datasets, consistent with disclosed embodiments.

### DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof may occur or be performed simultaneously, at the same point in time, or concurrently.

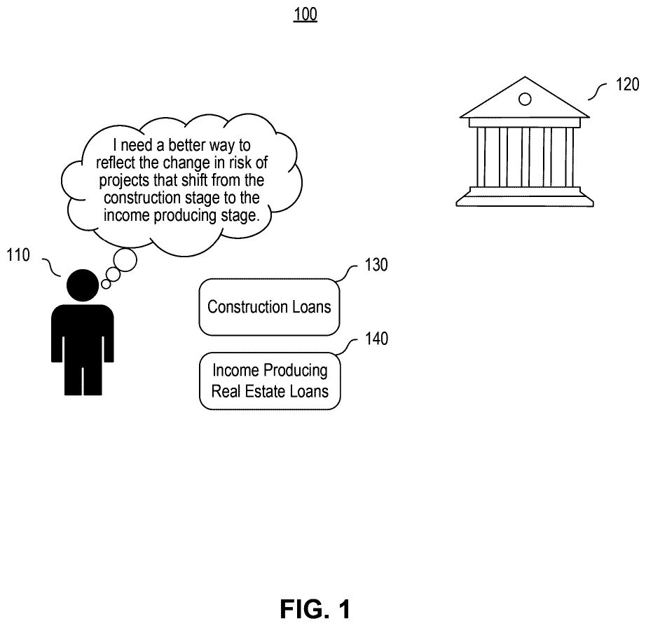

FIG. 1 illustrates an exemplary application for assessing credit risk across distinct portfolios, consistent with disclosed embodiments. Exemplary system 100 represents a system for assessing credit risk across distinct portfolios, which may include assessing portfolios individually. System 100 may lack the ability to efficiently assess credit risk by integrating the portfolios. System 100 shows two distinct portfolios, construction loans 130 and income-producing real estate loans 140. The construction loans 130 portfolio may include loan obligations related to a construction project. For example, a real estate developer may require financing to develop land and create a building, such as an apartment complex or single-family home. To obtain financing, the developer may take on a loan obligation from a financial institution. In other words, the developer borrows money, becoming an obligor, based on terms and conditions set forth in the loan obligations. Financial institutions typically manage a plurality of loan obligations and group them into portfolios based on similar arrangements. For example, all loan obligations related to developing land and new constructions maybe grouped together in a portfolio, while all loan obligations related to income producing for single family homes may be in a separate portfolio. However, there are scenarios where a loan obligation may transition from one stage to another. For example, a developer may have a loan obligation related to creating an apartment complex or hotel. During construction, the loan obligation may be characterized as a construction loan, but after the apartment complex or hotel is built, it may be recharacterized as an income-producing real estate loan 140.

As illustrated in FIG. 1, entity 120, which may be an individual, a financial institution, or an organization, may need to predict risk across portfolios that share some common features. Entity 110 may be an individual, such as an individual who works for an entity, such as entity 120. As illustrated in FIG. 1, entity 110 may wish to ensure that entity 120 is capturing their predicted risk in an accurate and consistent manner. As previously mentioned, these loan obligations, such as the construction loans 130 and income-producing real estate loans 140, may shift between stages, and by extension, across portfolios. By modeling each portfolio individually, several drawbacks may arise. First, shared features (e.g., loan-to-value ratio, loan-to-value ratios, and market conditions) may be defined, transformed, or weighted differently across the separate models, which may lead to inconsistent treatment of economically similar risk exposures. Second, portfolio-specific analysis methodologies may introduce discontinuities when a loan transitions between portfolios (e.g., a hotel construction loan that converts to an income-producing loan upon opening), which may cause an abrupt increase or decrease in estimated probability of default that reflects methodological differences rather than a real change in underlying conditions; such discontinuities may impair portfolio monitoring and result in inefficient resource allocation. Third, operating duplicative models for substantively similar data may waste resources by increasing computational load and analyst effort. The systems and methods disclosed herein utilize a modular approach to creating an integrated model to capture predicted risk, while allowing entities 120 and 110 to act on the best information available. While FIG. 1 only illustrates an entity 110 and one entity 120, the disclosed systems and methods may be applicable to any number of entities 110, entities 120, or any other persons or entities consistent with the present disclosure.

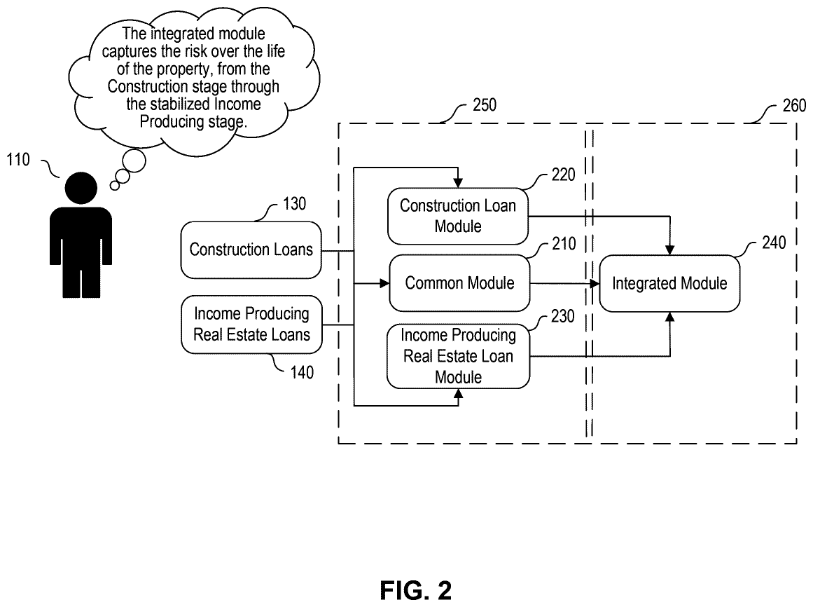

As illustrated in FIG. 2, creating the integrated risk module may include a variety of steps. The embodiment shown in FIG. 2 is merely illustrative.

FIG. 2 illustrates an example flow environment for creating an integrated module, consistent with the disclosed embodiments. As shown in FIG. 2, there may be a plurality of loan data and modules required to implement the risk modeling needs illustrated in FIG. 1. As illustrated in FIG. 2, there may be loan data regarding specific categories such as construction loans 130 or income-producing loans 140. This loan data may include information such as the obligor's loan history, their equity in the real estate, the loan amount, the value of the property, the terms or repayment on the loan, interest rates, and time to maturity. Different types of loans may include distinct types of loan data. For example, income-producing property may include loan data such as estimated rent payments, actual rent payments, or vacancy rates on similar properties. Construction loans may include distinct data that income-producing properties may not possess such as construction risks or the track record of a developer.

As illustrated in FIG. 2, the distinct data for construction loan obligations 130, such as the track record of a developer, may be stored within construction loan module 220. Conversely, distinct data for income-producing loans 140, such as vacancy rates, may be sent to income-producing real estate loan module 230. The common module 210 may include loan data types that are common between all the categories of loans. For example, construction loan obligations 130 and income-producing loans 140 both have data related to interest rates. As a result, the interest loan data from both the income-producing loans 140 and construction loan obligations 130 will be stored in the common module 210.

In some embodiments, even for shared features, factors such as time-to-maturity (TTM) may be treated differently across modules. For example, although TTM may be shared between construction loans and income-producing loans, obligor default risk may be especially elevated during the construction stage. Accordingly, in the Construction module, TTM may be implemented as a binary indicator (e.g., TTM<4 quarters=1; otherwise=0). To stabilize ratings during stage transitions (e.g., a one-way transition from construction to income-producing), TTM may be muted in the integrated step by setting it to a constant value of 1 for all construction loans, which may reduce volatility in a predicted variable. This and other modeling choices may improve integration stability due to feature specific dynamics.

Once all the loan data is sent and stored within a module, the system may proceed to the module regression stage 250. Under the module regression stage 250, each module may run separate generalized linear models (GLMs), such as logistic regression. The output of the module regression stage 250 may be a logit score associated with each module. The output may represent the log-odds of an event occurring, such as default on a loan obligation. To obtain a logit score, \hat{γ}, a linear regression model may be used, such as the formulas seen below. The formula contains the logit score, estimated coefficients, and independent variables denoted as \hat{γ}, βₙ, and xₙ respectively. Estimated coefficients are calculated to best fit the regression model. In other words, the coefficients are adjusted to fit the model by observing actual outcomes of historical data such as the construction loan default rate for a previous year. Independent variables consist of the loan data that likely contribute to the probability of an outcome, such as defaulting on a loan.

\hat{γ}_{Construction Loan Module Logit Score}=β₁(developer track record)+β₂(construction risks) . . . +βₙxₙ

\hat{γ}_{Income Producing Real Estate Loan Module Logit Score}=β₁(vacancy rates)+β₂(rental income) . . . +βₙxₙ

\hat{γ}_{Common Module Logit Score}=β₁(interest rates)+β₂(loan to value ratio) . . . +βₙxₙ

Once the logit score of each module is sent to the integrated module 240, as FIG. 2 illustrates, the system may proceed to the integrated regression stage 260. Under the integrated regression stage 260, the integrated module 240 may perform another linear regression using the logit scores from the module regression stage 250 to obtain a combined log-odds of an event occurring. The formula below contains the logit score of each module, estimated coefficients, and a dependent variable denoted as [symbol] , βₙ, and Y respectively. During all phases of regression, estimated coefficients may be optimized to create the best fit using techniques such as the maximum likelihood method for estimation.

Y_{Default Risk}=β₁(1 or 0)(\hat{γ}_{Construction Loan Module Logit Score})+β₂(1 or 0)(\hat{γ}_{Income Producing Real Estate Loan Module Logit Score})+β₂(\hat{γ}_{Common Module Logit Score})

When dependent variables have binary outcomes (e.g., defaulted, good standing) logistic regression may be used to bound an output range between zero and one. For example, a specific loan obligation may either be in default or in good standing. Default may be represented by one and good standing may be represented by zero. However, the goal of logistic regression is to estimate the probability of occurrence and not the value of the variable itself. Therefore, because linear regression has been used in our example, the equation must still be transformed. The logistic function shown below may transform the linear regression models used in both the module regression stage 250 and integrated regression stage 260 into a probability between zero and one. Accordingly, the result from the integrated regression stage 260, Y, may then be used in the logistic function shown below to transform Y into a probability between zero and one. However, one of ordinary skill in the art may use other regression techniques to best fit their needs based on factors such as model fit and the nature of the dependent variables (e.g., binary, continuous).

$$P ( Default ) = \frac{1}{1 + {e}^{- {Y}_{Default Risk}}}$$

The example flow environment illustrated in FIG. 2 provides more stability in risk calculations across the life of a loan because it may capture loan obligations shifting between stages, and by extension, across portfolios. Using methods described in the present disclosure, because of consistent model factors and coefficients when utilizing the disclosed methods and systems, it may be less likely that there will be excessive jumps when obligors transition from construction to income-producing loans. Additionally, by implementing the modular structure in this disclosure, related portfolios may be modeled under one single process, allowing a portion of the previously needed human and technology resources to be freed for other prioritized uses. In contrast, by modeling each portfolio in isolation, there could be a sharp increase or decrease in predicted risk when a loan transitions because the common factors, which are being analyzed twice, may be handled inconsistently by each model.

The example environment illustrated in FIG. 2 provides better interpretability and transparency. For example, the separation of loan stages risk factors, after excluding common factors, enables entities, such as entity 110 or entity 120, to explain the rating change due to specific distinct or common factors. In other words, whether the change is due to a loan stage specific factor (e.g., construction delays) or a common factor (e.g., market interest rates). This helps identify the granular risk drivers and consequently diversify portfolios as needed. In other words, identifying risk drivers helps portfolio development by allowing an entity to strategically take on loan obligations to adjust their risk. An additional benefit may be the reduction of personnel and computer resources. For example, by implementing the modular structure in this disclosure, related portfolios may be modeled under one single process, allowing a portion of the previously needed human and technology resources to be freed for other prioritized uses. Specifically, analyst time spent reconciling inconsistent assumptions or weights, validation and audit work on similar models, and computational resources (e.g., processor bandwidth) for duplicative models can be significantly reduced. These resources (e.g., analysts and processors) can then be redirected to other activities such as improving underlying data quality.

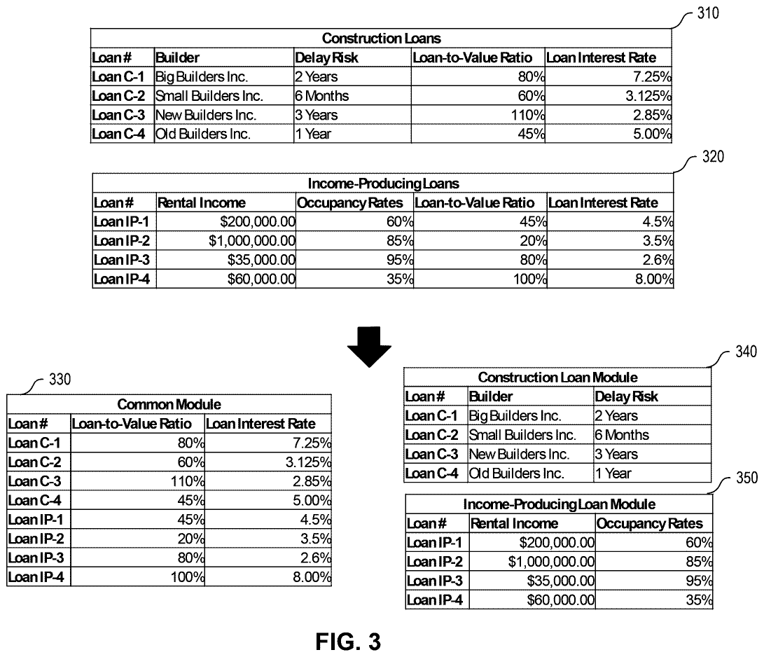

FIG. 3 illustrates example datasets and modules used by the disclosed systems to model financing risk across the lifecycle of a real estate loan. As FIG. 3 illustrates, five related tables are shown: a Construction Loans table 310, an Income Producing Loans table 320, a Common Module table 330, a Construction Loan Module table 340, and an Income Producing Loan Module table 350. Collectively, these tables demonstrate how distinct loan features (e.g., builder or rental income) are captured alongside shared loan features (e.g., loan to value ratio, interest rate) and may enable both modular analysis and integrated modeling of risk as discussed in FIG. 2.

The Construction Loans table 310 shows example construction loans (e.g., Loan C-1 through Loan C-4) and records features associated with each loan, including Builder, Delay Risk (e.g., “2 Years,” “6 Months”), and standard credit metrics such as Loan to Value Ratio and Loan Interest Rate. The Income Producing Loans table 320 shows income-producing loans such as rental properties or hotels (e.g., Loan IP-1 through Loan IP-4) and records distinct features associated with this income producing stage, including Rental Income and Occupancy Rate, together with the shared features across all loans (e.g., Loan to Value Ratio and Interest Rate).

The Common Module table 330 may integrate the shared attributes for both construction and income producing loans. As FIG. 3 illustrates, the Common Module table 330 lists each loan's Loan to Value Ratio and Interest Rate regardless of the category of loan (e.g., construction or income-producing). This common subset may enable consistency across heterogeneous loan stages. The Construction Loan Module table 340 may isolate construction specific features such as Builder and Delay Risk. The Income Producing Loan Module table 350 may isolate income producing specific features such as Rental Income and Occupancy Rate. This modularization similarly may allow the model to incorporate operating performance predictors only when the asset is stabilized or otherwise generating income.

As FIG. 3 and the disclosed embodiments illustrate, during a loan stage transition (e.g., when a construction loan reaches completion and converts to an income producing loan), stage specific records may migrate from the Construction Loan Module 340 to the Income Producing Loan Module 350, while the Common Module 330 may preserve and update the shared credit fields (e.g., Loan to Value Ratio). This structure may enable consistent downstream analytics such as recalculating risk, repricing, or covenant monitoring using both common and stage specific inputs.

By separating stage specific attributes into the Construction Loan Module table 340 and Income Producing Loan Module table 350, while centralizing shared attributes in the Common Module 330, the system may: (i) train module level models on stage specific features, (ii) train an integrated model on the union of common and stage specific features, and (iii) produce a more stable estimated value (e.g., probability of default) across loan stages.

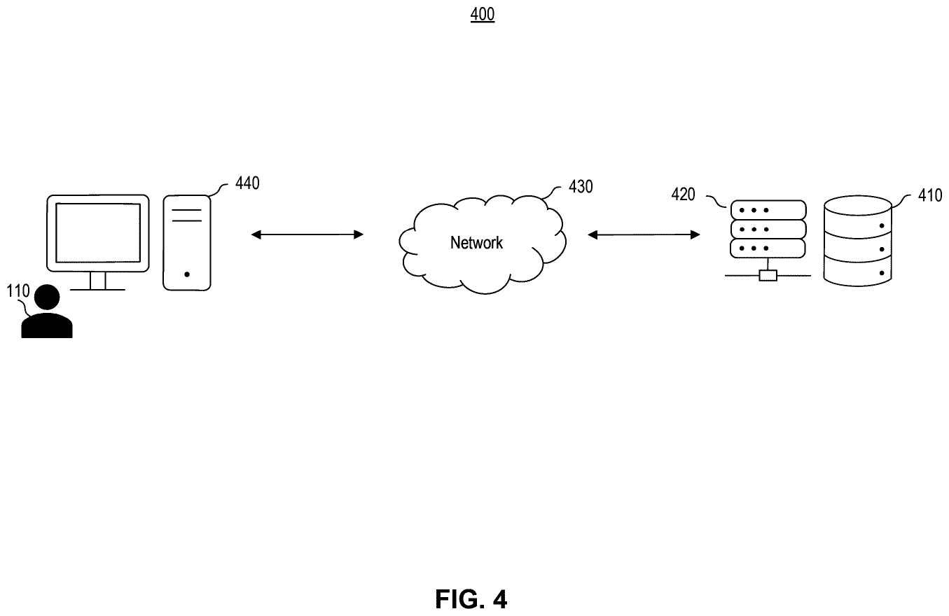

FIG. 4 is a diagram of an exemplary system environment 400 for creating risk models for financing decisions, portfolios, or loan obligations, consistent with disclosed embodiments. System environment 400 may include one or more financial institution endpoint devices 440, one or more computing devices 420, and one or more databases 410, as shown in FIG. 4.

The various components of system 400 may communicate over a network 430. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 400 is shown as a network-based environment, it is understood that in some embodiments, one or more aspects of the disclosed systems and methods may also be used in a localized system, with one or more of the components communicating directly with each other.

Computing device 420 may include any form of remote computing device configured to receive, store, and transmit data. For example, computing device 420 may be a server configured to store files accessible through a network (e.g., a web server, application server, virtualized server, etc.). Computing device 420 may interact with a database 410, for example, a loan information database, to receive and/or store information. Database 410 may be included on a volatile or non-volatile, magnetic, semiconductor, tape, optical, removable, non-removable, or other type of storage device or tangible or non-transitory computer-readable medium. Database 410 may also be part of computing device 420 or separate from computing device 420. When database 410 is not part of computing device 420, computing device 420 may exchange data with database 410 via a communication link. Database 410 may include one or more memory devices that store data and instructions used to perform one or more features of the disclosed embodiments. Database 410 may include any suitable databases, ranging from small databases hosted on a work station to large databases distributed among data centers. Database 410 may also include any combination of one or more databases controlled by memory controller devices (e.g., server(s), etc.) or software. For example, database 410 may include document management systems, Microsoft SQL™ databases, SharePoint™ databases, Oracle™ databases, Sybase™ databases, other relational databases, or non-relational databases, such as mongo and others. Although one database 410 is shown in FIG. 4, the system environment 400 may include one or more databases 410, which may be used to store various types of information associated with customers of a financial institution.

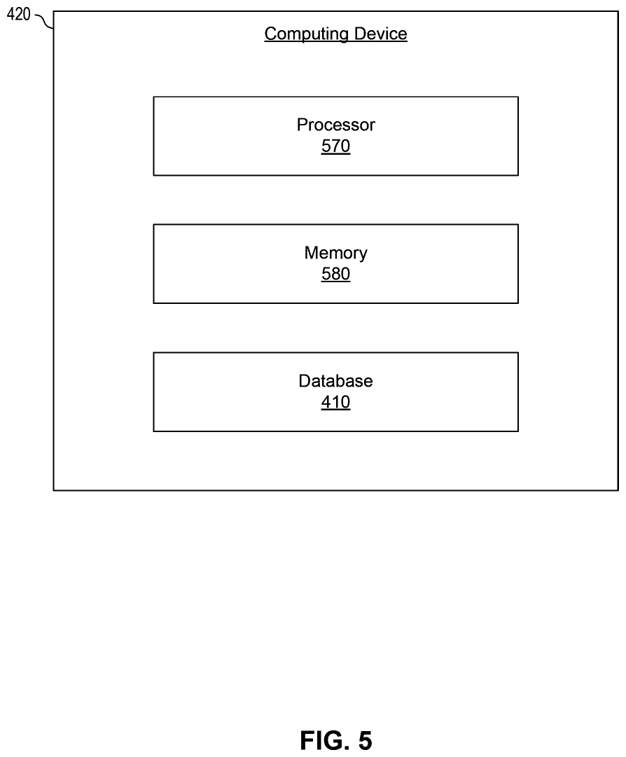

FIG. 5 is a block diagram showing an example computing device 420, consistent with the disclosed embodiments. As described above, computing device 420 may be one or more devices configured to allow data to be received and/or transmitted by system 400 (e.g., a server, etc.) and may include one or more dedicated processors and/or memories. For example, computing device 420 may include a processor (or multiple processors) 570, and a memory (or multiple memories) 580. Computing device 420 may include one or more digital and/or analog devices that may allow computing device 420 to communicate with other machines and devices, such as other components of system 400. Computing device 420 may include one or more input/output devices. Computing device 420 may include a screen for displaying communications to a user. In some embodiments computing device 420 may include a touch screen. Computing device 420 may include other components known in the art for interacting with a user. Computing device 420 may also include one or more digital and/or analog devices that may allow a user to interact with system 400, such as touch-sensitive area, keyboard, buttons, or microphones.

Processor 570 may take the form of, but is not limited to, one or more integrated circuits (IC), including application-specific integrated circuit (ASIC), microchips, microcontrollers, microprocessors, embedded processor, all or part of a central processing unit (CPU), graphics processing unit (GPU), digital signal processor (DSP), field-programmable gate array (FPGA), server, virtual server, system on an chip (SOC) or other circuits suitable for executing instructions or performing logic operations. Furthermore, according to some embodiments, processor 570 may be from the family of processors manufactured by Intel®, AMD®, Qualcomm®, Apple®, NVIDIA®, or the like. Processor 570 may also be based on the ARM architecture, a mobile processor, or a graphics processing unit, etc. The disclosed embodiments are not limited to any type of processor configured in computing device 420. In some embodiments, processor 570 may be a special purpose processor configured to perform one or more of the operations described below.

Memory 580 may include one or more storage devices configured to store instructions used by processor 570 to perform functions related to computing device 420. The disclosed embodiments are not limited to particular software programs or devices configured to perform dedicated tasks. For example, memory 580 may store a single program, such as a user-level application, that performs the functions associated with the disclosed embodiments, or may include multiple software programs. Additionally, processor 570 may, in some embodiments, execute one or more programs (or portions thereof) remotely located from computing device 420. Furthermore, memory 580 may include one or more storage devices configured to store data for use by the programs. Memory 580 may include, but is not limited to a hard drive, a solid state drive, a CD-ROM drive, a peripheral storage device (e.g., an external hard drive, a USB drive, etc.), a network drive, a cloud storage device, or any other storage device.

Computing device 420 may include a database 410 as described with respect to FIG. 4. Database 410 may also be part of computing device 420 or separate from computing device 320. In some embodiments, computing device 420 may include one or more input/output devices, communications devices, displays, and/or other interfaces (e.g., server-to-server, database to-to-database, or other network connections). One or more of financial institution endpoint devices 440 may include components similar to those discussed with respect to computing device 420 and may perform functions similar to or different from those described above with respect to computing device 420.

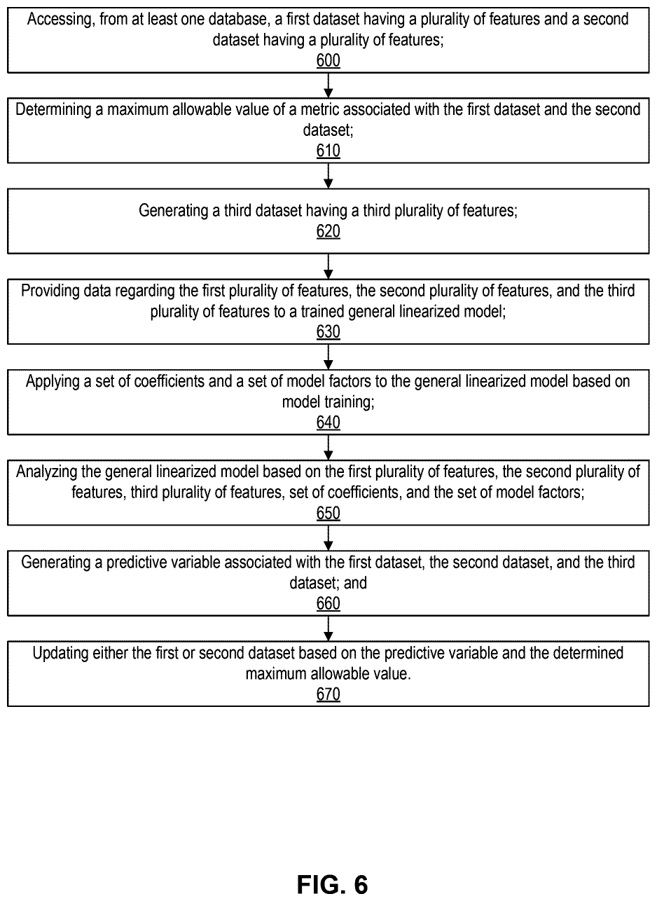

FIG. 6 is a flowchart illustrating an example process for feature analysis of at least two datasets, consistent with disclosed embodiments. The disclosed steps may be performed by a processor. At step 600, the process may include accessing, from at least one database, a first dataset having a plurality of features and a second dataset having a plurality of features. According to some embodiments, at least one of the first plurality of features and at least one of the second plurality of features may be a same feature. Further, according to some embodiments, at least one of the first plurality of features and at least one of the second plurality of features may be a distinct feature. With respect to distinct features, different types of loans may include distinct types of loan data. For example, income-producing property may include loan data such as estimated rent payments, actual rent payments, or vacancy rates on similar properties. Construction loans may include distinct data that income-producing properties may not possess such as construction risks or the track record of a developer. With respect to same features, different types of loans may include same types of loan data. For example, regardless of whether the loan is income-producing property or a construction, both loan types will include data such as loan-to-value ratios and market conditions.

According to some embodiments, the datasets may be retrieved from a centralized data repository or distributed databases connected via a network infrastructure, such as a local area network (LAN), wide area network (WAN), or cloud-based system.

For example, according to some embodiments, either a first or second dataset may include a portfolio of assets that may include loan obligations for either construction projects or income-producing real estate. Additionally, according to some embodiments, a plurality of features may include an obligor's financial ratios, equity in the real estate, loan amount, value of the property, terms or repayment on the loan, interest rates, and time to maturity. Different types of loans may include distinct types of loan data. For example, income-producing property may include loan data such as estimated rent payments, actual rent payments, or vacancy rates on similar properties. Construction loans may include distinct data that income-producing properties may not possess such as construction risks or the track record of a developer.

At step 610, the process may further include determining a maximum allowable value of a metric associated with the first dataset and the second dataset. In some embodiments, the maximum allowable value maybe an acceptable risk threshold and may be determined by assessing the risk tolerance of key stakeholders. This assessment may be done through a variety of methods. Such methods may include cost-benefit analysis, predicting the likelihood and impact of risks, utilizing historical data, assuring risk levels are compliant with regulatory requirements, or expert judgment. In some embodiments, the maximum allowable value maybe determined, wholly or in-part, by a statistical model, a person, a group of people, or agent(s) of a financial institution.

According to some embodiments, the maximum allowable value may be dynamically adjusted based on external conditions or requirements. For example, the acceptable risk threshold may be recalibrated in response to changes in market volatility, interest rate fluctuations, regulatory updates, or shifts in institutional risk appetite. The adjustment may be performed automatically by the system using real-time data feeds and predefined rules. In some embodiments, the system may incorporate external indicators such as macroeconomic factors, scraping the internet for data, or sector-specific performance metrics to inform the recalibration. This dynamic capability allows the model to remain aligned with evolving business objectives

At step 520, the process may further include generating a third dataset having a third plurality of features. According to some embodiments, the third plurality of features include the same feature of the first dataset and the second dataset.

At step 630, the process may further include providing data regarding the first plurality of features, the second plurality of features, and the third plurality of features to a trained general linearized model. According to some embodiments, the general linearized model may include, but may not be limited to, linear regression, logistic regression, ordinary least squares regression, or Poisson regression depending on the data being used to train the model.

According to some embodiments, the general linearized model may be trained on a plurality of single models, each model of the plurality of single models being trained on individual datasets. For example, a first single model may be trained exclusively on construction loan data, incorporating features such as developer track record, construction risk ratings, and projected build timelines. A second single model may be trained on income-producing real estate loan data, using features such as rental income, occupancy rates, and historical cash flow. According to some embodiments, the training process may be iterative, such that each single model and the general linearized model undergo repeated cycles of refinement. For example, each iteration may include adjusting model parameters, updating data sets, or incorporating additional data.

At step 640, the process may further include applying a set of coefficients and a set of model factors to the general linearized model based on model training. According to some embodiments, the set of coefficients may be determined during model training to minimize an error between actual outcome factors and predicted outcome factors. According to some embodiments, the set of model factors may be related to the dataset. For example, datasets related to financial loan portfolios (e.g., construction and income-producing real estate loans) may have model factors about loan-to-value ratios and obligor's loan history. Additionally, according to some embodiments, the general linearized model may be trained on the data according to all modules to be integrated such as the construction loan module, the income-producing real estate loan module, and the common module, as described with respect to FIG. 2.

At step 650, the process may further include analyzing the general linearized model based on the first plurality of features, the second plurality of features, third plurality of features, set of coefficients, and the set of model factors.

According to some embodiments, analyzing the general linearized model minimizes duplicate analysis on the same features in both the first dataset and second dataset after analyzing the third dataset having a plurality of features. For example, minimizing duplicate analysis may be achieved by consolidating shared features-such as interest rates and loan-to-value ratios-into the third dataset, which may serve as a unified representation of common attributes across loan portfolios. By isolating these features into a dedicated module, the system may avoid redundant computations and may ensure that shared factors are consistently weighted and interpreted across all portfolio types. This may also enhance model stability, particularly when loans transition between stages (e.g., from construction to income-producing).

At step 660, the process may further include generating a predictive variable associated with the first dataset, the second dataset, and the third dataset. According to some embodiments, the predictive variable indicates which model factors contributed to the predictive variable, and the predictive variable indicates a level of sensitivity within the model associated with the model factors. For example, in some embodiments, the predictive variable may represent the estimated probability of default for either dataset (e.g., loan portfolios). When calculating this probability, certain embodiments may further determine which factors (e.g., market conditions) contributed to the result and to what extent. More specifically, the process may assess how much each factor would need to change to produce a greater impact on the predicted probability of default. Factors requiring only minimal changes to significantly alter the outcome may be classified as highly sensitive. Some embodiments may also identify factors that exerted the least influence on the probability of default and note whether they are highly sensitive.

According to some embodiments, the predictive variable may be associated with a saliency map based on the first plurality of features, the second plurality of features, and the third plurality of features, the saliency map displaying a level of sensitivity for each of the first plurality of features, the second plurality of features, and the third plurality of features. For example, in the context of loan portfolios, the saliency map may highlight that loan-to-value ratio and developer track record are highly influential for construction loans, while rental income and occupancy rates are more sensitive for income-producing loans. This visualization on the saliency map enables stakeholders to understand which features are driving risk predictions, facilitating more informed decision-making. Additionally, the saliency map may be used to audit model behavior, detect bias, and validate that the model may be responding appropriately to known risk factors. For example, the saliency map may help audit model behavior by showing which factors the model relies on most. Further, it may help detect bias by checking if certain features have an outsized influence, which might indicate improper weighting. Further, it may also validate the model's response to known risk factors by confirming that important variables, such as loan-to-value ratios, impact predictions in the way they should. In some embodiments, the saliency map may be rendered as a heatmap, ranked list, or interactive dashboard, allowing users to explore feature importance across different datasets and modules.

At step 670, the process may further include updating either the first or second dataset based on the predictive variable and the determined maximum allowable value. For example, according to some embodiments, financial institutions 120 may sell, terminate, adjust future or existing loan terms, or keep the portfolio as-is based on the predictive variable (e.g., probability of default) in order to update either dataset (e.g., loan portfolios) to be below a maximum allowable value (e.g., acceptable risk). Further, according to some embodiments, the updated financing positions could be completed by a third-party. In other words, a party other than the party setting and calculating the predictive variable and maximum allowable value. Alternatively, updating the financing positions could be completed automatically by a computer.

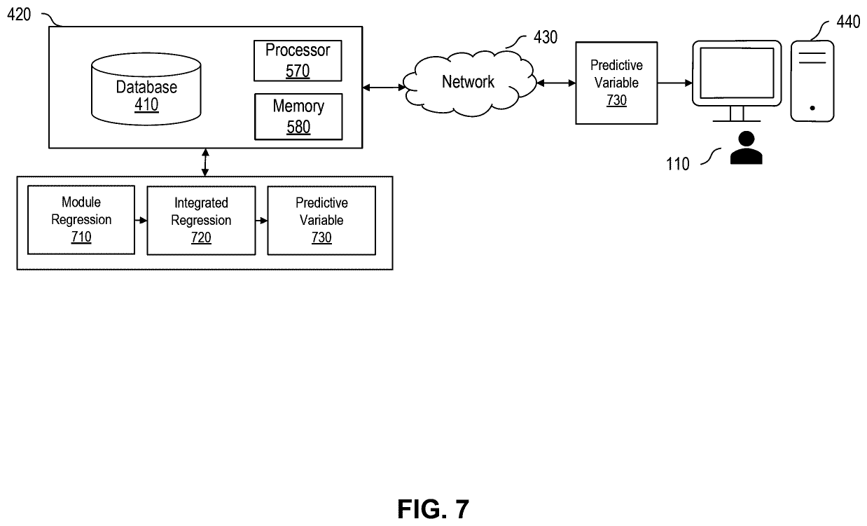

FIG. 7 is a diagram of an exemplary system architecture for feature analysis of at least two datasets. The system may include entity 110, which may represent a financial institution, risk manager, or analyst responsible for assessing credit risk across distinct loan portfolios. Entity 110 may interact with the system through endpoint device 440, which may include a desktop computer, laptop, or other computing interface capable of authoring, executing, and reviewing model outputs.

The system may include a code execution environment hosted on a computing device 420, which contains a processor 570, memory 580, and access to a database 410. Processor 570 may execute a trained general linearized model that applies regression techniques to multiple datasets such as a construction loan portfolio or income-producing real estate loan portfolio. The memory 580 may store intermediate results, model coefficients, and transformation logic, while the database 410 may contain the source datasets-such as construction loan data and income-producing real estate loan data-along with schema definitions and historical performance metrics.

The system architecture includes a module regression component 710, which performs regression analysis on individual modules such as those described in FIG. 2. Each module corresponds to a distinct dataset and may generate a logit score that may represent the probability of default or other risk metrics. For example, the construction loan module may analyze developer track records and construction risks, while the income-producing module may evaluate vacancy rates and rental income. A common module may also be included to capture shared features such as interest rates and loan-to-value ratios.

The outputs of the module regression stage are passed to an integrated regression component 720, which performs a second-level regression using the logit scores from each module. This integrated regression produces a unified risk assessment that accounts for both distinct and common features across datasets. The integration ensures consistency in model coefficients and reduces volatility in predicted risk when loans transition between stages.

The system further includes a predictive variable 730, which applies the trained model to generate a predictive variable associated with the first, second, and third datasets. This variable may represent the probability of default or other risk indicators and may include sensitivity analysis to identify which features most significantly influence the prediction. The predictive variable may be used to update either the first or second dataset based on a comparison with a maximum allowable value, and may be enabled to dynamically adjust either of the portfolios.

All components may communicate over a network 430, which may include local area networks (LAN), wide area networks (WAN), or cloud-based infrastructure. This networked environment supports distributed processing, remote database access, and integration with enterprise risk management systems.

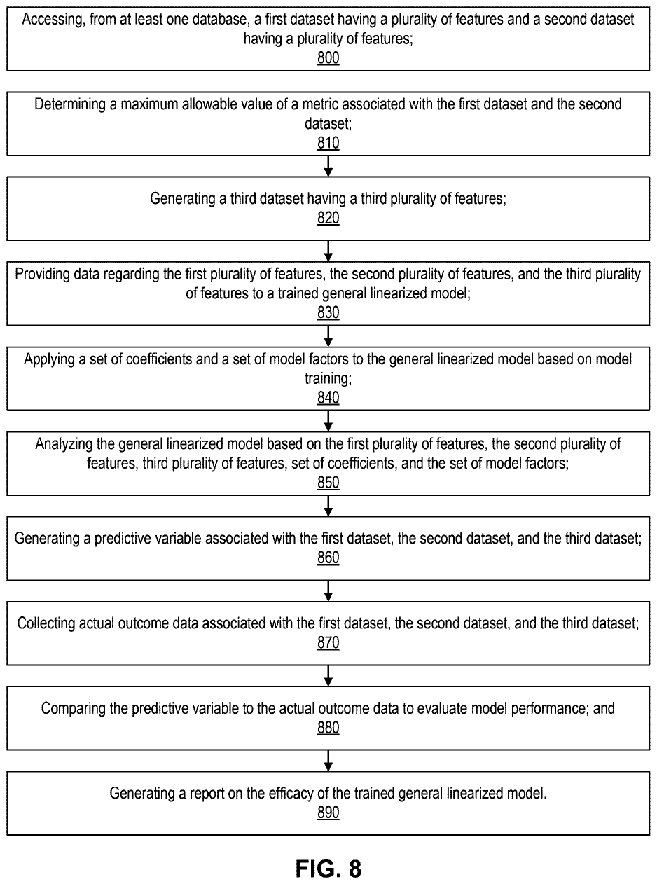

FIG. 8 is a flowchart illustrating an example process for improving model performance and predictive analysis across multiple datasets. The disclosed steps may be performed by a processor. At step 700, the process may include accessing, from at least one database, a first dataset having a plurality of features and a second dataset having a plurality of features.

According to some embodiments, at least one of the first plurality of features and at least one of the second plurality of features is a same feature. Further, according to some embodiments, at least one of the first plurality of features and at least one of the second plurality of features may be a distinct feature.

At step 810, the process may further include determining a maximum allowable value of a metric associated with the first dataset and the second dataset.

At step 820, the process may further include generating a third dataset having a third plurality of features.

According to some embodiments, the third plurality of features include the same feature of the first dataset and the second dataset.

At step 830, the process may further include providing data regarding the first plurality of features, the second plurality of features, and the third plurality of features to a trained general linearized model.

At step 840, the process may further include applying a set of coefficients and a set of model factors to the general linearized model based on model training.

According to some embodiments, the set of coefficients may be determined during model training to minimize an error between actual outcome factors and predicted outcome factors.

At step 850, the process may further include analyzing the general linearized model based on the first plurality of features, the second plurality of features, third plurality of features, set of coefficients, and the set of model factors.

At step 860, the process may further include generating a predictive variable associated with the first dataset, the second dataset, and the third dataset.

According to some embodiments, the predictive variable indicates which model factors contributed to the predictive variable, and the predictive variable indicates a level of sensitivity within the model associated with the model factors

At step 870, the process may further include collecting actual outcome data associated with the first dataset, the second dataset, and the third dataset. According to some embodiments, collecting actual outcome data may include scraping internet sources for relevant data associated with the first dataset and the second dataset.

At step 880, the process may further include comparing the predictive variable to the actual outcome data to evaluate model performance.

According to some embodiments, the process may further include the set of coefficients and the set of model factors being dynamically adjusted based on the comparison between the predictive variable and the actual outcome data. This adjustment may be performed using feedback mechanisms that may allow the model to refine its parameters in response to observed discrepancies between predicted and actual outcomes. For example, if the model consistently underestimates default risk for a subset of construction loans, the coefficients associated with developer track record or construction risk may be recalibrated to improve predictive accuracy. This continuous learning loop may ensure alignment with real-world performance.

Further, according to some embodiments, the first dataset, the second dataset, and the third dataset may be updated responsive to a determination that a confidence threshold in the predictive variable is achieved. For example, the confidence threshold may be defined by statistical metrics such as standard error, and may vary depending on portfolio type, regulatory requirements, or institutional risk tolerance. Once the threshold is met, the system may initiate updates to the datasets-such as making modification to loan obligation to adjust risk exposure. These updates may be executed manually by analysts or automatically by the system.

At step 890, the process may further include generating a report on the efficacy of the trained general linearized model. According to some embodiments, this may include a graph or table comparing the predictive variable and the actual outcome data. For example, the graph may visualize trends over time, such as predicted versus actual default rates across different loan portfolios, while the table may present side-by-side comparisons of key metrics including predicted probabilities and error.

According to some embodiments, the process may further include a causality analysis to determine which features most significantly influence shifts in the predictive variable. For example, this analysis may help to isolate which variables are not only associated with risk but are likely to drive changes in predicted outcomes. To illustrate further, in a loan portfolio model, causality analysis may reveal that a sudden drop in rental income may be a leading indicator of increased default probability, whereas changes in interest rates may have a delayed or indirect effect.

Further, the causality analysis may include artificial intelligence and machine learning techniques are used to analyze sudden changes in data that result in significant changes in the predictive variable. For example, if the model detects a sharp decline in rental income across multiple portfolios, the AI may correlate this with an external event, such as a natural disaster, legislative change, or pandemic. The system may then annotate the model output with explanatory metadata, indicating that the drop in rental income was likely caused by the external event, thereby enhancing interpretability and decision-making.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present disclosure.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages (e.g., Python, R, and SAS). The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the disclosure, which are, for clarity, described in the context of separate embodiments, may also be provided in combination in a single embodiment. Conversely, various features, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A computer-implemented method for feature analysis of at least two datasets, the method comprising the following operations performed by one or more processors:
accessing, from at least one database, a first dataset having a plurality of features and a second dataset having a plurality of features,
wherein at least one of the first plurality of features and at least one of the second plurality of features is a same feature; and
wherein at least one of the first plurality of features and at least one of the second plurality of features is a distinct feature;
determining a maximum allowable value of a metric associated with the first dataset and the second dataset;
generating a third dataset having a third plurality of features,
wherein the third plurality of features include the same feature of the first dataset and the second dataset;
providing data regarding the first plurality of features, the second plurality of features, and the third plurality of features to a trained general linearized model;
applying a set of coefficients and a set of model factors to the general linearized model based on model training,
wherein the set of coefficients is determined during model training to minimize an error between actual outcome factors and predicted outcome factors;
analyzing the general linearized model based on the first plurality of features, the second plurality of features, third plurality of features, set of coefficients, and the set of model factors;
generating a predictive variable associated with the first dataset, the second dataset, and the third dataset,
wherein the predictive variable indicates which model factors contributed to the predictive variable, and the predictive variable indicates a level of sensitivity within the model associated with the model factors;
updating either the first or second dataset based on the predictive variable and the determined maximum allowable value.

2. The method of claim 1, wherein the general linearized model is trained on a plurality of single models, each model of the plurality of single models being trained on individual datasets.

3. The method of claim 1, wherein the predictive variable is associated with a saliency map based on the first plurality of features, the second plurality of features, and the third plurality of features, the saliency map displaying a level of sensitivity for each of the first plurality of features, the second plurality of features, and the third plurality of features.

4. The method of claim 1, wherein analyzing the general linearized model minimizes duplicate analysis on the same features in both the first dataset and second dataset after analyzing the third dataset having a plurality of features.

5. The method of claim 1, wherein the general linearized model is a logistic regression model.

6. The method of claim 1, wherein the updating the dataset regarding the first plurality of features and the dataset regarding the second plurality of features based on the predictive variable and the maximum allowable value is done automatically responsive to a determination that a confidence threshold in the predictive variable is achieved.

7. The method of claim 1, wherein the maximum allowable value is dynamically adjusted based on external conditions or requirements.

8. A system for feature analysis of at least two datasets comprising:
a memory device storing program instructions; and
a processor configured to execute the program instructions to:
access, from at least one database, a first dataset having a plurality of features and a second dataset having a plurality of features,
wherein at least one of the first plurality of features and at least one of the second plurality of features is a same feature; and
wherein at least one of the first plurality of features and at least one of the second plurality of features is a distinct feature;
determine a maximum allowable value of a metric associated with the first dataset and the second dataset;
generate a third dataset having a third plurality of features,
wherein the third plurality of features include the same feature of the first dataset and the second dataset;
provide data regarding the first plurality of features, the second plurality of features, and the third plurality of features to a trained general linearized model;
apply a set of coefficients and a set of model factors to the general linearized model based on model training,
wherein the set of coefficients is determined during model training to minimize an error between actual outcome factors and predicted outcome factors;
analyze the general linearized model based on the first plurality of features, the second plurality of features, third plurality of features, set of coefficients, and the set of model factors;
generate a predictive variable associated with the first dataset, the second dataset, and the third dataset,
wherein the predictive variable indicates which model factors contributed to the predictive variable, and the predictive variable indicates a level of sensitivity within the model associated with the model factors;
update either the first or second dataset based on the predictive variable and the determined maximum allowable value.

9. The system of claim 8, wherein the general linearized model is trained on a plurality of single models, each model of the plurality of single models being trained on individual datasets.

10. The system of claim 8, wherein the predictive variable is associated with a saliency map based on the first plurality of features, the second plurality of features, and the third plurality of features, the saliency map displaying a level of sensitivity for each of the first plurality of features, the second plurality of features, and the third plurality of features.

11. The system of claim 8, wherein the program instructions to analyze the general linearized model minimizes duplicate analysis on the same features in both the first dataset and second dataset after analyzing the third dataset having a plurality of features.

12. The system of claim 8, wherein the general linearized model is a logistic regression model.

13. The system of claim 8, wherein the updating the dataset regarding the first plurality of features and the dataset regarding the second plurality of features based on the predictive variable and the maximum allowable value is done automatically responsive to a determination that a confidence threshold in the predictive variable is achieved.

14. The system of claim 8, wherein the maximum allowable value is dynamically adjusted based on external conditions or requirements.

15. A non-transitory computer-readable medium storing a set of instructions for feature analysis of at least two datasets, the set of instructions comprising:
access, from at least one database, a first dataset having a plurality of features and a second dataset having a plurality of features,
wherein at least one of the first plurality of features and at least one of the second plurality of features is a same feature; and
wherein at least one of the first plurality of features and at least one of the second plurality of features is a distinct feature;
determine a maximum allowable value of a metric associated with the first dataset and the second dataset;
generate a third dataset having a third plurality of features,
wherein the third plurality of features include the same feature of the first dataset and the second dataset;
provide data regarding the first plurality of features, the second plurality of features, and the third plurality of features to a trained general linearized model;
apply a set of coefficients and a set of model factors to the general linearized model based on model training,
wherein the set of coefficients is determined during model training to minimize an error between actual outcome factors and predicted outcome factors;
analyze the general linearized model based on the first plurality of features, the second plurality of features, third plurality of features, set of coefficients, and the set of model factors;
generate a predictive variable associated with the first dataset, the second dataset, and the third dataset,
wherein the predictive variable indicates which model factors contributed to the predictive variable, and the predictive variable indicates a level of sensitivity within the model associated with the model factors;
update either the first or second dataset based on the predictive variable and the determined maximum allowable value.

16. The non-transitory computer-readable medium of claim 15, wherein the general linearized model is trained on a plurality of single models, each model of the plurality of single models being trained on individual datasets.

17. The non-transitory computer-readable medium of claim 15, wherein the predictive variable is associated with a saliency map based on the first plurality of features, the second plurality of features, and the third plurality of features, the saliency map displaying a level of sensitivity for each of the first plurality of features, the second plurality of features, and the third plurality of features.

18. The non-transitory computer-readable medium of claim 15, wherein the program instructions to analyze the general linearized model minimizes duplicate analysis on the same features in both the first dataset and second dataset after analyzing the third dataset having a plurality of features.

19. The non-transitory computer-readable medium of claim 15, wherein the general linearized model is a logistic regression model.

20. The non-transitory computer-readable medium of claim 15, wherein the maximum allowable uncertainty is dynamically adjusted based on external conditions or requirements.

21.-40. (canceled)
